(19) United States
(12) Patent Application Publication
(10) Pub. No.: US 2007/0281134 A1
(43) Pub. Date: Dec. 6, 2007

(54) Coated rigid plastic packaging materials with holographic image applied at press speed

(75) Inventor: Steve R. Young, Plano, TX (US)

Correspondence Address: LOCKE LIDDELL & SAPP LLP;ATTN: DOCKETING DEPT., 2200 ROSS AVENUE, SUITE 2200, DALLAS, TX, 75201-6776, US

(73) Assignee: Great Western Industries, Inc.

(21) Appl. No.: 11/443,334

(22) Filed: May 30, 2006

(51) Int. Cl. B32B 3/00

(52) U.S. Cl. 428/172

(57) ABSTRACT

Articles formed at least in part from a rigid plastic substrate having a holographic image embossed on a coated surface section thereof by impressing a corresponding holographic image disposed repeatedly on a continuous roll of film against a UV-curable coating applied to at least one surface portion of the plastic substrate with simultaneous curing of the coating to solidify the image. Packages, package components, signage, printed materials and the like embodying rigid plastic substrates with the embossed holographic images are disclosed.

### BACKGROUND OF THE INVENTION

1. Field of the Invention

This invention relates to the direct transfer of a holographic image to a printed, coated, or printed and coated, rigid plastic substrate that is clear, tinted or opaque. The substrate can include, without limitation, rigid plastic substrates intended for use in plastic packaging, plastic folding cartons, plastic sleeves, plastic inserts and windows for packages and cartons, plastic signage and other printed products made of rigid plastics. As used herein, the term “rigid plastic” refers to web rolls or sheets of plastic material of the type that can be used, for example, to make products such as those identified above, particularly by the use of processes such as thermoforming, vacuum forming, die-cutting, folding, sealing, and the like. Such rigid plastics are to be distinguished and differentiated from web rolls of flexible, thin-film plastics such as those commonly used to make products like stretch wrap, shrink wrap or over wrap, and from injection molded plastic packages such as CD and DVD cases. One aspect of this invention relates to plastic packages, and more particularly, to rigid plastic packages and packaging materials having a hologram embossed in a coating or spot applied on either an inside or outside surface of at least one wall section. Another aspect of this invention relates to a method for transferring a holographic image to any coating or ink that can be applied to a rigid plastic substrate at a coating station of a printing press.

2. Description of Related Art

In recent years, the application of holograms to various types of plastic packages has become well known, and the improved marketability of packages decorated with holograms has been firmly established. With the conventional technology, holograms are typically applied to metallized foils or to thin, flexible plastic films that are subsequently laminated onto paper or plastic substrates intended for various purposes, Various methods and end use applications involving holograms are disclosed, for example, in U.S. Pat. Nos. 5,164,227; 6,737,170; 6,761,958; and 6,916,516; and in Chinese Patent Nos. 1127431 and 1276332.

Although attractive packages comprising holographic images can be made using conventional methods, the speeds at which the holograms can be applied to the substrates are typically much slower than desired. Accordingly, there remains a need for rigid plastic substrates to which holographic images can be applied at web or sheet-fed press speeds, and for end-use articles made from such substrates. Packages having a hologram applied at press speeds to the inside or outside surface of at least one clear, tinted or transparent wall section, and packages having spot applied or registered holographic images, either alone or in combination with printing, are also needed.

### SUMMARY OF THE INVENTION

According to the present invention, clear and opaque rigid plastic substrates are disclosed that have holographic images embossed directly onto the substrates at press speeds without the need for laminating foil or film. Such rigid plastic substrates can be used for a wide variety of applications, including without limitation packaging, recyclable packaging, foldable cartons and package windows, signage, printed products, and the like. The substrates can be continuous webs or die-cut blanks, with or without printing, and can have holographic images embossed directly onto a suitable substrate, or into UV-curable resin coatings that are generally applied or spot applied to the substrate, or that are registered in relation to other images or graphics. The surface onto which the holographic image is applied can ultimately be used as either an inside or outside surface of a finished article, or as an insert that is otherwise usable inside of, or in combination with, a finished article.

According to one preferred embodiment of the invention, die-cut rigid plastic sheets are disclosed that comprise a holographic image embossed at press speeds. The plastic sheets usable as target substrates for the holographic image are preferably made of a resin such as polyethylene terephthalate (PET), amorphous polyethylene terephthalate (APET), polyvinyl chloride (PVC), polylactic acid (PLA), polypropylene (PP), polystyrene (PS) and high density polyethylene (HDPE), all of which are well known to those of skill in the art. The holographic image is preferably embossed into a coating comprising an ink or resin that is instantaneously curable by the application of ultraviolet light to prevent outflow of the coating. The holographic image is most preferably maintained on a reusable, continuous web of plastic film, and is applied to the coating by pressing a section of the film bearing a reverse image into contact with the coating immediately following application of the coating to the substrate. UV-curing desirably commences simultaneously with application of the coating and holographic image, and, for most substrates, can be accomplished by directing the ultraviolet light source through the substrate.

According to another preferred embodiment of the invention, a rigid plastic package is disclosed that has a holographic image embossed in a UV-curable resin coating on a surface of at least one clear or transparent section of a substrate used to construct a wall section of the package. The hologram is most preferably disposed on an inside surface and plainly visible to a prospective purchaser when the package is held in a suitable orientation to an external light source. It should be understood, however, that the holographic image can likewise be applied to a substrate surface that is ultimately on the outside of a package, in which case the substrate used to make the wall section can be either clear or opaque.

According to another preferred embodiment of the invention, a package is disclosed that comprises a continuous side wall having a single seam and two opposed end walls that conform to opposed openings defined by the continuous side wall. The end walls can be either fixedly or releasably attached to the side wall as desired, but will preferably cooperate with the side wall to form a substantially closed package. It should also be appreciated that the side wall can further comprise folds with various radii of curvature to produce, for example, packages having substantially circular, rectangular, oval, or other symmetrical or asymmetrical cross-sections.

According to another preferred embodiment of the invention, a method is disclosed for applying a holographic image at printing press speeds to a clear plastic web or sheet of rigid plastic packaging material by coating a portion of the web or sheet with a coating comprising a substantially transparent, ink or polymeric resin that is sufficiently viscous to avoid flow-out prior to curing; embossing a holographic image into the coating layer; and curing the coating immediately afterward, before the holographic image devolves. The holographic image is preferably embossed into the coating layer by contacting and impressing on the coating a second web of plastic film moving at the same speed, so that there is no substantial relative movement between the two contacting surfaces in the press direction when the image is formed. The second web is desirably drawn from a roll onto which the holographic source image has previously been sequentially repeated at predetermined spacings and positions that correspond to the spacings and positions needed for the packages to be formed from the printed web or sheet. After releasing from the package web or sheet, the source film for the holographic images is preferably rewound onto another roll for continued reuse until such time as the source images have degraded to a point where they are incapable of transferring images having the requisite clarity and definition to the coating on the press web or sheet.

The packages disclosed herein are characterized by holographic images that can be applied at web or sheet-fed press speeds from a roll of polymeric film comprising a plurality of such images that are repeated sequentially at desired spacings and positions. The roll of polymeric film can be reused repeatedly to further reduce embossing costs. Because the holographic images can be disposed on the inside of the package, they are not susceptible to wear or image degradation due to infiltration of contaminants into the image striations without the necessity of covering the image with another clear protective layer. Other advantages and beneficial characteristics of the subject packages will become apparent to those of ordinary skill in the art upon reading this disclosure.

### BRIEF DESCRIPTION OF THE DRAWINGS

The apparatus of the invention is further described and explained in relation to the following drawings wherein:

FIG. 1 is a perspective view of one preferred embodiment of the package of the invention;

FIG. 2 is an exploded perspective view of the package of FIG. 1;

FIG. 3 is a cross-sectional elevation view taken along line 3-3 of FIG. 2;

FIG. 4 is an enlarged, cross-sectional plan view taken along line 4-4 of FIG. 1;

FIG. 5 is an enlarged, cross-sectional elevation view taken along line 5-5 of FIG. 4;

FIG. 6 is an exploded perspective view of an alternate embodiment of the invention;

FIG. 7 is a perspective view of another preferred embodiment of the invention depicting an article having a holographic image embossed on a section of spot-applied coating disposed on an outside surface of the article;

FIG. 8 is an enlarged, cross-sectional plan view taken along line 8-8 of FIG. 7; and

FIG. 9 is an enlarged, cross-sectional elevation view taken along line 9-9 of FIG. 8.

Like reference numerals are used to indicate like parts in all figures of the drawings.

### DESCRIPTION OF THE PREFERRED EMBODIMENTS

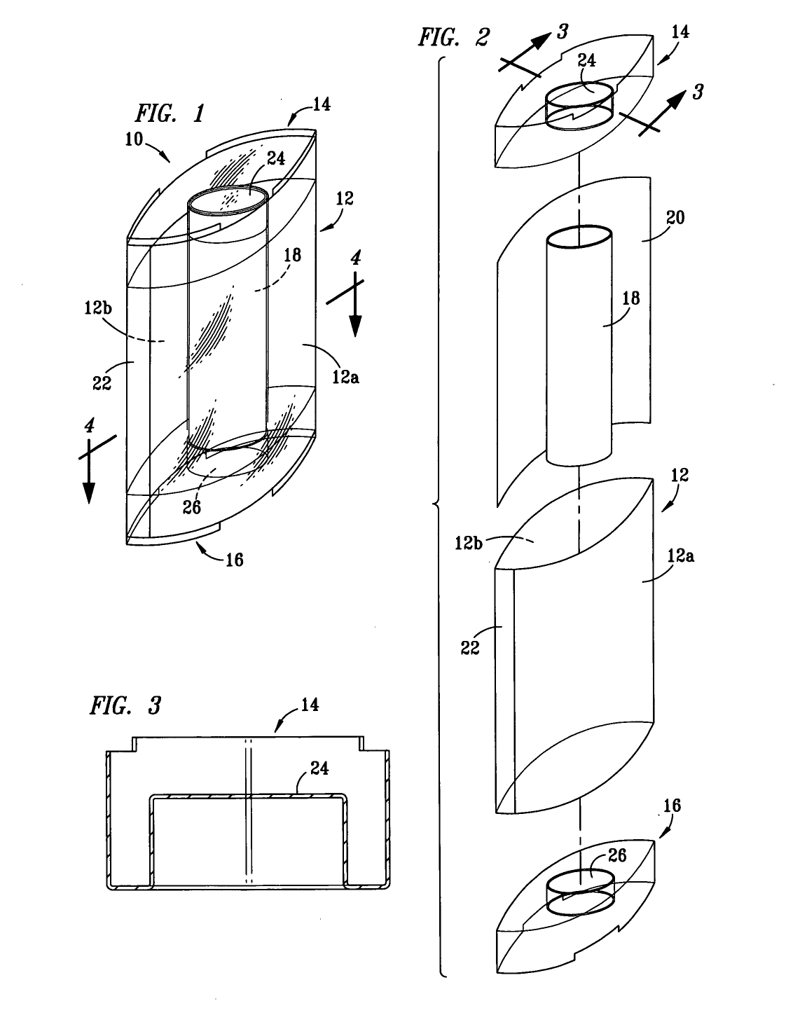

Referring to FIGS. 1-5, rigid plastic package 10 comprises a continuous side wall 12 and end caps 14, 16 having slidably engageable flange portions that cooperate with side wall 12 to form a substantially closed container. Continuous side wall 12 is formed from a continuous sheet, but further comprises front portion 12a and rear portion 12b that are bounded on one side by a fold line and on the other side by overlapping seam 22 that is preferably sealed with a substantially clear, commercially available adhesive that is not visible in these simplified drawings. It should be understood that the configuration of package 10 as depicted in the drawings is merely exemplary of an infinite number of differently shaped packages that can be made within the scope of the invention. Thus, for example, packages having more sides, more seams, different cross-sections, more or fewer fold lines, and the like, can likewise be made within the scope of the invention subject to the other considerations and structural elements as disclosed herein and recited in the accompanying claims.

Continuous side wall 12 and end caps 14, 16 can be made of the same or different materials. Continuous side wall 12 is preferably substantially clear or transparent, which terms are used interchangeably herein, and must necessarily include at least a transparent wall section through which hologram 30 (best seen in FIG. 5) can be viewed by an outside observer, presumably a potential consumer examining package 10. The material used to make side wall 12 is preferably selected from clear, durable polymeric resins including without limitation those made of polymers such as PET, APET, PVC, PLA, PP, PS, and HDPE.

Referring to FIGS. 2, 4 and 5, coating layer 28 is preferably deposited on the inside surface of front portion 12a of side wall 12 and has hologram 30 embossed in it so as to be visible through front portion 12a. Coating layer 28 and hologram 30 are preferably applied to a substrate that is used to form side wall 12 according to the method that is further described below. Coating layer 28 preferably comprises a conventional, commercially available ink or polymeric resin, preferably clear or translucent, that is sufficiently flowable to be evenly applied across the substrate surface, that has sufficient viscosity to receive a hologram 30 impressed into it, and that is curable substantially instantaneously by the application of ultraviolet light to the extent necessary to resist flow-out. The coating used to form coating layer 28 can also comprise a cross-linker or other similarly effective component that is activated by ultraviolet light to effect rapid curing. Although coating layer 28 is depicted in FIGS. 1, 4 and 5 as being applied only to front portion 12a of side wall 12, it should be appreciated that packages and other articles of the invention can be constructed with holograms embossed as disclosed herein in a coating on a substrate surface that forms any surface of the subject article. Preferably, any holographic art embossed on a surface that forms part of the interior of a package will be viewable through at least one transparent outer wall section of the package.

Package 10 is preferably made by starting with a die-cut sheet of clear, rigid plastic substrate to be used as sidewall 12. That portion of the sheet to which a holographic image is to be applied is desirably coated in a conventional printing press with a coating layer 28 having a thickness somewhat greater than the depth of the deepest striation of hologram 30 to be embossed in coating layer 28. According to a particularly preferred embodiment of the invention, hologram 30 is formed by contacting coating layer 28, while it is still soft and pliable following application to the substrate, with a reverse of the hologram that is previously formed on a plastic film. Where the holographic image is symmetrical, the use of a reverse on the transfer film is not required. The plastic film is preferably disposed on a continuous roll having the same holographic image repeated sequentially at spacings and positions corresponding to the spacings and positions needed to properly position and transfer images onto a plurality of substrates for use in making a plurality of packages 10. When hologram 30 from the film roll is impressed into coating layer 28, the substrate is preferably moving at the same rate and direction of travel as the transfer film so that there is substantially no relative horizontal movement between them. As hologram 30 is being embossed into coating layer 28, coating layer 28 is preferably irradiated with ultraviolet light, or treated by other similarly effective means sufficient to cure coating layer 28 quickly to prevent run-out and to “freeze” the transferred hologram on the coated substrate.

Either before or afterward the holographic image is applied to the substrate, other printing layers can be applied to the substrate to achieve other graphic objectives and the hologram-bearing transfer film is wound onto a take-up roll for subsequent reuse. By use of this method, holograms can be embossed on substrates used to make packages of the invention much more quickly, efficiently and cheaply than through the use of other known technology involving the lamination of individual hologram-bearing foils or films onto a substrate. Following application of the hologram and any associated printed text or graphics to the substrate, the substrate can be die cut, folded, glued or otherwise assembled as necessary using conventional means to produce package 10 having the desired shape, structure and configuration. Where the embossed hologram 30 is disposed on an inside surface of package 10, the hologram is desirably viewable through a clear sidewall section of the package.

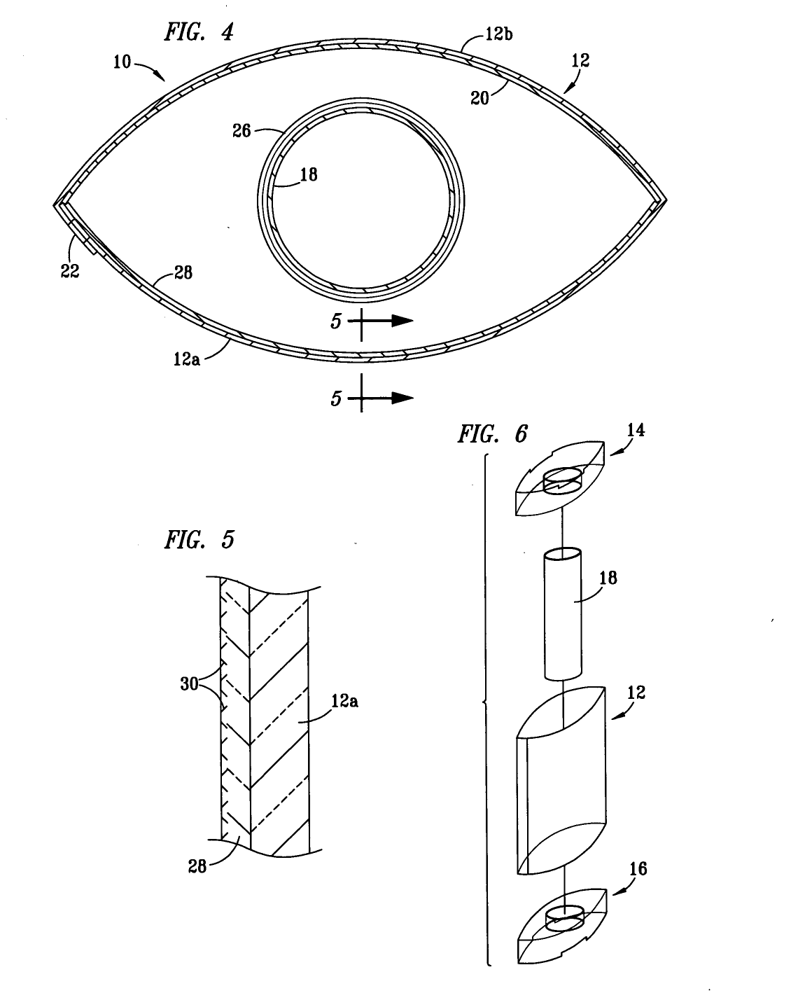

Referring again to FIGS. 2 and 4, optional insert 20 having substantially the same shape and perimeter dimensions as back portion 12b of side wall 12 is inserted adjacent to, or optionally attached to, the inside surface for aesthetic reasons such as, for example, providing a contrasting background color to add depth to hologram 30 embossed on the inside surface of front portion 12a, or to complement whatever product is to be displayed inside package 10. Similarly, as shown in FIGS. 1-3, tubular insert 18 is optionally disposed vertically between front portion 12a and back portion 12b and is further supported by cooperatively shaped recesses 24, 26 in end caps 14, 16, respectively. For comparative purposes, FIG. 6 depicts a similar package comprising side wall 12, end caps 14, 16, and tubular insert 18, but does not include the optional insert 20 as shown in FIGS. 2 and 4. It will be appreciated that the use of inserts such as those described for illustrative purposes herein are not required for the invention and if used, can be made of clear or opaque plastic, or of paper, or of any other suitable material and in any other suitable configuration for a particular package 10 and product with which it is used.

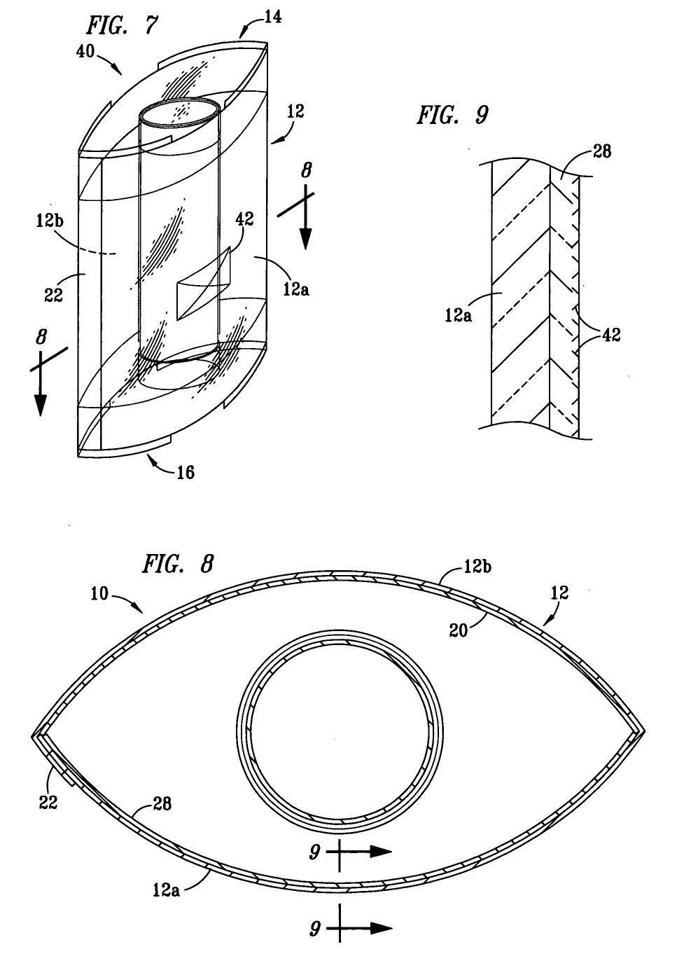

Similarly to FIGS. 1, 4 and 5, FIGS. 7-9 disclose another embodiment of the invention wherein a holographic image is spot-applied to a portion of the front outside wall of a package 40 that is otherwise identical in shape and configuration to package 10 as discussed above. In this embodiment, a different holographic image 42 is applied to a coating layer 28 of UV-curable ink or resin that is spot-applied to a die-cut substrate at a position that corresponds to the desired placement on finished package 40. With the use of an embossed holographic image 42 as disclosed herein, as opposed to the use of a laminated foil or film bearing a holographic image as disclosed in the prior art, it is believed to be unnecessary to further protect the holographic image 42 with an additional outer layer of protective film, thereby further reducing manufacturing time and material costs.

It will now become apparent to those of ordinary skill in the art upon reading this disclosure that packages can also be made through use of the invention that comprise the embossed holographic images in combination with thermoformed inserts. Alternatively, the subject invention can also be used to produce hologram-bearing inserts for thermoformed packages or package components to which holograms as disclosed herein cannot be directly applied. Through use of the present invention, articles can be easily and quickly made that comprise both printing and holographic images, including for example, packages having both printing and holograms on the same surfaces, or on oppositely facing surfaces (such as printing on the inside and a hologram on the outside, or vice versa) of rigid plastic substrates. The spot application of holographic images to plastic substrates at press speeds is another significant advantage of the subject invention. Such substrates can be used for packages in an infinite number of different package configurations, or as windows for packages made of paper or board, or in other applications such as signage and promotional materials, or in many other applications as will now become apparent to those who read this disclosure in view of the accompanying drawings.

It is therefore intended that the scope of the invention as disclosed herein be limited only by the broadest interpretation of the appended claims to which the inventors are legally entitled.

We claim:

1. An article comprising a rigid plastic substrate having a holographic image embossed in a UV-curable coating material disposed on a surface thereof.

2. The article of claim 1 wherein the rigid plastic substrate is selected from the group consisting of polyethylene terephthalate (PET), amorphous polyethylene terephthalate (APET), polyvinyl chloride (PVC), polylactic acid (PLA), polypropylene (PP), polystyrene (PS), high density polyethylene (HDPE), and mixtures thereof.

3. The article of claim 1 wherein the article is a package having inside and outside walls, and wherein the holographic image is disposed on an inside wall.

4. The article of claim 1 wherein the article is a package having inside and outside walls, and wherein the holographic image is embossed on an outside wall.

5. The article of claim 1 wherein the UV-curable coating material is selected from the group consisting of UV-curable inks and polymeric resins.

6. The article of claim 1 wherein the UV-curable coating material is spot-applied to a portion of the surface.

7. The article of claim 1 wherein a portion of the surface further comprises printing.

8. The article of claim 1 wherein a portion of the article further comprises printing.

9. The article of claim 3 wherein printing is applied to at least a portion of the outside wall.

10. The article of claim 4 wherein printing is applied to at least a portion of the inside wall.

11. The article of claim 1 wherein the holographic image embossed in the coating material corresponds to and is transferred from a second holographic image disposed on a continuous roll of plastic film bearing a plurality of repeated embodiments of the second holographic image.

12. The article of claim 11 wherein the second holographic image is a reverse of the holographic image.

13. A package comprising a rigid plastic portion made from a substrate having a holographic image embossed in a UV-curable coating material disposed on a surface thereof.

14. The package of claim 13 having at least one transparent wall section, wherein the holographic image is embossed in a coating material disposed on an inside surface of the transparent wall section.

15. The package of claim 13 having at least one plastic wall section, wherein the holographic image is embossed in a coating material disposed on an outside surface of the wall section.

16. The package of claim 13 wherein the substrate comprises a polymeric resin selected from the group consisting of polyethylene terephthalate (PET), amorphous polyethylene terephthalate (APET), polyvinyl chloride (PVC), polylactic acid (PLA), polypropylene (PP), polystyrene (PS), high density polyethylene (HDPE), and mixtures thereof.

17. The package of claim 13 wherein the coating material is selected from the group consisting of clear, coatable polymeric resins and inks.

18. The package of claim 13, comprising a continuous side wall and two end caps.

19. The package of claim 18 wherein the two end caps are engageable with the continuous side wall.

20. The rigid package of claim 18 wherein the continuous side wall comprises at least one fold line.

21. The package of claim 20 wherein the continuous side wall comprises a plurality of fold lines.

22. The package of claim 13, further comprising at least one insert member.

23. The package of claim 21 wherein at least one insert member is thermoformed.

24. The package of claim 13 wherein the holographic image is embossed by contacting the coating with a polymeric film comprising a corresponding hologram.

25. The package of claim 24 wherein the polymeric film comprises a plurality of images of the corresponding hologram repeated sequentially in spaced apart relation.

26. The package of claim 13 wherein the substrate is cut from a continuous web.

27. The package of claim 13 wherein the substrate is a die-cut sheet.

28. The package of claim 22 wherein the insert member is made of a material selected from the group consisting of paper, paperboard, foil and plastic.

29. The package of claim 13 wherein the holographic image is embossed in the coating at web or sheet-fed press speeds.

30. The package of claim 13 wherein the holographic image is cured by the application of ultraviolet light to the coating material.
